(19) United States
(12) Patent Application Publication
(10) Pub. No.: US 2019/0188680 A1
(43) Pub. Date: Jun. 20, 2019

(54) METHOD AND SYSTEM APPLIED TO FINANCIAL TRANSACTIONS VIA MOBILE OR EMBEDDED DEVICES

(71) Applicant: Banco Agibank S.A, Porto Alegre (BR)

(72) Inventor: Marciano Testa, Porto Alegre (BR)

(73) Assignee: Banco Agibank S.A, Porto Alegre (BR)

(21) Appl. No.: 16/323,231

(22) PCT Filed: Oct. 25, 2017
(86) PCT No.: PCT/BR2017/050321

§ 371 Date: Feb. 4, 2019

(30) Foreign Application Priority Data
Nov. 16, 2016 (BR) BR 10 2016 026832

(51) Int. Cl. G06Q 20/32; G06Q 20/40

(52) U.S. Cl. CPC G06Q 20/3223; G06K 19/06037; G06Q 20/40145; G06Q 20/3224

(57) ABSTRACT

The present invention relates to a system used for financial transactions from a bank account using a mobile or embedded device and includes installation of a program (5) directly connected to a central data processing unit (2) of a financial institution (1) by means of a web server (3), making it possible to open an account and enabling the user to perform financial transactions instantaneously following registration because of the identification of users compared to existing solutions, enabling real-time verification of the credit status of the user. The opening of the account directly links same to the telephone number of the user, which is used to identify the account holder. The determination of a user history/profile with the respective services and places most commonly visited using a geolocation system is also provided, as well as the option of monitoring charging and automatic division of bills and expenses incurred in establishment.

In general terms, this invention belongs to the segment of applied systems and methods for processing data for financial purposes and refers, more specifically, to a system and method for performing financial transactions through a mobile or embedded device.

### KNOWN STATE OF THE ART

The continuous modernization of facilitating systems and methods used to optimize and guarantee the security of bank account holders is notable. Generally speaking, technologies are currently being developed which, thus, enable the user to perform any kind of financial transaction without having to go to a bank agency, leading to greater convenience, and avoiding the need for queuing and other inconveniences. One of the most innovative solutions, which has revolutionized the way in which account holders can manage and operate their accounts, consists of the development of systems which comprise applications for installation on mobile devices (smart phones, tablets, notebooks) which represent the fastest growing channel for financial transactions currently in existence.

According to data from the Federação Brasileira de Bancos—Febraban (Brazilian Federation of Banks) up to 2015, the ranking of the largest channels of communication between banks and their clients was, respectively, internet banking, mobile banking and in third place, ATM machines. However, the growth in the mobile banking segment based on the development of systems developed for applications for making payments, transferences, contracting credit and performing consultations has been notable, principally due to the increased number of people with Internet access. In addition to this, the dissemination of mobile devices (such as tablets and smart phones) configured for downloads and/or the installation of programs has also facilitated the user's access to a range of activities, including bank transactions. As such, visits to bank branches have been reduced to those occasions when holders need to withdraw money or when it is necessary to present some sort of formal document for contracting a given service.

The use of these systems generally involves easy access, involving intuitive fields that facilitate the user's navigation of the bank services available and connecting directly to the financial institution. Generally speaking, for the user to use these applications and request financial services directly through his/her mobile device, a registration needs to be completed and a login recorded, through the insertion of personal data and a personal password. In addition to this, in most cases, the bank itself provides a personal identifier so that the user identity may be proved prior to accessing the bank account. Password generating tools of the token type also tend to be used in order to guarantee the security of this kind of banking transaction with the user's receiving a specific connection password in some cases, for each access.

Having said this, there are some alternatives that represent the current state of the art which are described in patent documents. Some examples may be observed, such as in the case of patent n^{o} BR 10 2014 027124-4—“Method, user device and system for sending banking transaction information”, owned by the institution ITAÚ UNIBANCO S.A., which describes a system, device and method for sending information about financial transactions from a user device. This technology comprises the steps of initiating a computer application configured to allow access to the account of a financial institution, to select the type of transaction desired from a financial services provider management system and, based on these steps, the computer application automatically sends an order for the creation of a token and sends it together with the information about the transaction to the management system. Unlike the system proposed in this report, the method described above is mainly intended to facilitate access to bank accounts through the generation of a code automatically registered on a token, dispensing with need for manual typing of said code by the user.

Another alternative can be seen in application n^{o} BR 10 2012020433-9—“Portable device system and application for managing data of clients” which describes an application system to be installed on portable data devices, by bank clerks, financial institutions and other related institutions, to facilitate the contracting of services, and security in providing service to clients. This application is integrated into the banks' computing systems, through the “web services” developed to interact in conjunction with the other bank systems. However, this solution differs from the present invention inasmuch as it consists of an application designed for use by the clerk of the bank institution, who is responsible for carrying out the requests made by the client.

As an example of an international alternative regarding systems and methods for financial transactions related to bank accounts, we can cite the documentation of U.S. Pat. No. 5,903,881—“Personal online banking with integrated online statement and checkbook user interface”, where a method is presented that should be implemented through the software on a computer and the respective system, which provides for a user interface, allowing for the integration of different tasks associate with personal online accounts. The method presents to the user a complete vision of the status of its account and funds available, supporting online account payment actions, and electronic transferences, among others. However, the above system has been developed specifically for implementation on computers and does not comprise the facilities of the system and method proposed in the present invention, such as the possibility of opening an account online, the identification of a user through the reading of the QR code, payments to establishments through QR code reading on the purchase of products or services acquired, among other solutions resulting from the implementation of the system for a mobile device, which is the subject of this description.

In addition to these systems described in the patent documents, it is possible to find other applications also developed specifically for monitoring and managing bank accounts by the holders thereof. Many banks possess their own application for mobile devices, generally for smart phones, one example of which can be observed in the application of Banco Original, which consists of a digital bank. This institution allows for the opening of an online account, the carrying out of bank transfers, payments of bills through a barcode reader, financial planning, statements and withdrawals with cards at ATMs. However, this technology only allows the user to open a bank account online, without the need to go to a physical agency, but still using the same procedures necessary to open an account at an agency. This method renders necessary the provision of various documents in order that the request be sent for analysis, which takes considerable time before the user is authorized to begin its financial transactions. The functionalities of the system proposed by Banco Original, moreover, do not allow the identification of the sites of consumption through geolocation technology, or the use, as authentication, of the user's telephone number for association and communication with his/her bank account.

It is worth highlighting that said applications, despite consisting of tools for facilitating financial transactions, still possess various security weaknesses, since the vast majority do not possess specific mechanisms for this purpose. In addition to this, these systems do not always confer security on the systems' connection with the bank that configures the server web to which the application connects. As a result, given all the existing inconveniences existing in the systems and methods currently used, and described above in the state of the art, there is a clear gap in the market for the creation of a new system for facilitating financial transactions by bank account holders. Furthermore, the current state of the art does not comprise a solution that uses the user's telephone number as identification information, in order to standardize the form of personal identification to effect transactions.

For this reason, the present invention comprises a method and system which provides options and solutions for the administration of bank accounts by the holder of the account using his/her own mobile device. Using the user's telephone number as its identifier, it is possible to establish a standard of international identification. Ultimately, this invention seeks to establish a system with automatic user and credit identification technology, payment of establishments/people through QR code, availability of geolocation, the possibility of creating groups of users, among other innovations, to ensure the security and ease of financial transactions.

### Novelties and Objectives of the Invention

With the aim of eradicating the flaws in the current state of the art highlighted above, this patent seeks to propose a solution to problems related to the difficulty of performing banking transactions using an innovative method and system, which comprises a program for implementation on mobile and/or embedded devices. In addition to providing certain options for transactions in a form already comprised in the state of the art, the proposed system presents varied innovative characteristics which facilitate the identification of users thus representing an improvement on the systems and programs currently known. To identify each user at the time of the creation of the account, a QR identification code thereof is generated.

For this purpose, the proposed system connects a mobile device to a banking network through a program directly connected to a central data processing unit of the financial institution by means of a web server. One of the greatest innovations provided by this system consists of the possibility of opening an account online using the program, associating the opening of the account directly with the user's telephone number, which will be responsible for identifying the user in any transaction. Thus, the system provides access to alternatives for transactions through the instantaneous verification of the identity and credit status of the user, avoiding waiting times for the analysis of credit as occurs in all the alternative systems and methods related to the opening of bank accounts. As such, as each telephone number is globally unique, the method and system that are the objects of this description will facilitate any kind of financial transaction between individuals. Which is to say, a standardization of user identification information can be hereby observed, avoiding moreover possible errors in the completion of the data of the beneficiary user (such as bank agency, current account and other information generally necessary at present).

Furthermore, the proposed invention carries out an identification of the profile and user with the respective services and locations most often frequented, through the implementation of the system and/or geolocation resource, facilitating the control of the bank account. In addition to this, the options for payments and transfers available in the system may be activated using the QR code reader of the establishment/user through the device camera. As such, each code is associated with an account for the performance of transactions, which represents an advance in relation to the existing systems.

Another service provided, which still doesn't exist in other systems, consists of the management of charges and the possibility of creating groups of users, where all participants must have the system installed on their devices. By way of example, using this system it is possible to establish a total value to be divided up between the participants, providing a charge in real time and monitoring the complying and breaching parties respectively. The system automatically detects whether a payment has been made and this confirmation of payment may also be made manually by the user who issued the charge.

Finally, this invention also provides an alternative for making withdrawals without the need for a card, in an innovative manner in relation to the existing methods. This invention allows—based on a request for a withdrawal, informing the value and user password on the device—for a code to be generated with a time limit for its use. Thus, a user can go to an establishment, without needing to use a card to make a withdrawal, based on the confirmation of the code and telephone number.

### DESCRIPTION OF THE ATTACHED DESIGNS

In order that this invention can be fully understood and put into practice by any professional from the technological segment, it will be described clearly, concisely and sufficiently, based on the attached designs, which illustrate and supplement it, as listed below:

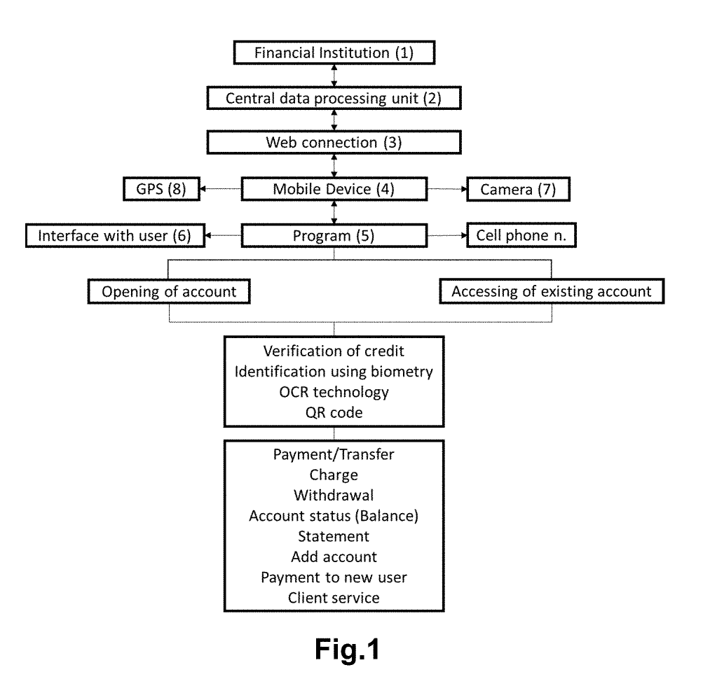

FIG. 1 represents the diagram explaining the connection of the component elements of the system with a program for banking transactions, and its functionalities in accordance with this invention.

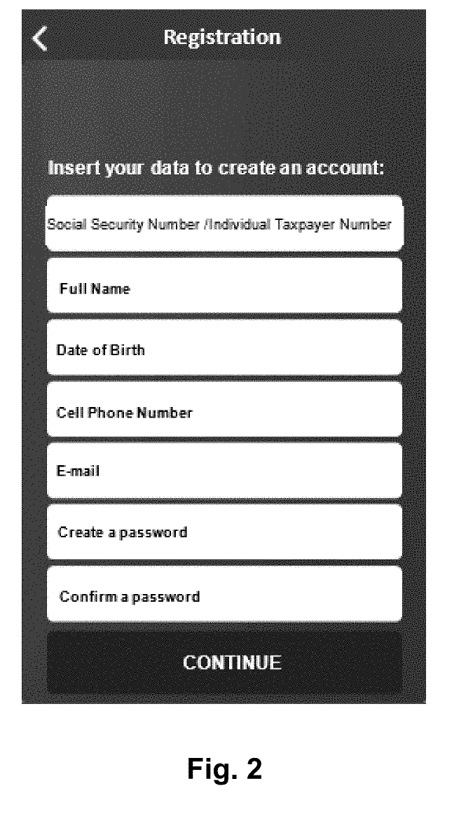

FIG. 2 represents the registration screen of the program comprising obligatory completion fields for identification of the user.

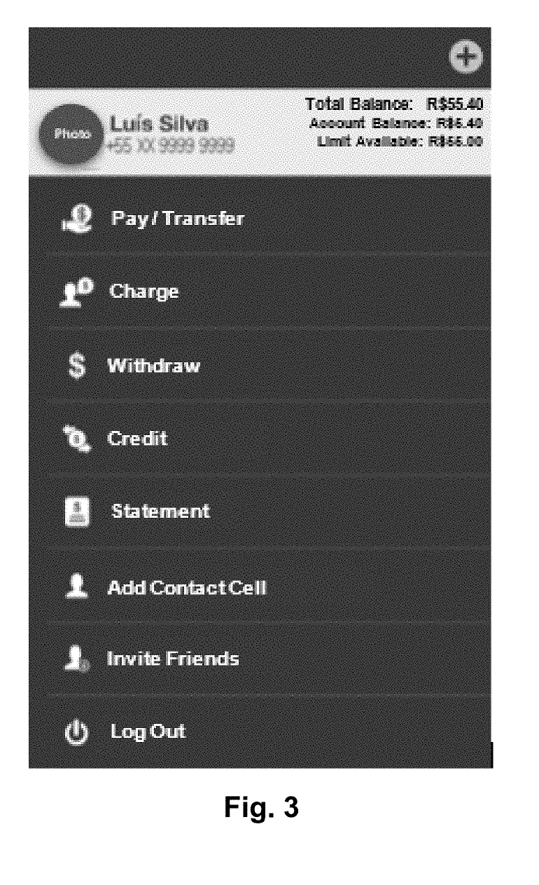

FIG. 3 represents the start screen of the program with the options of resources available to the user.

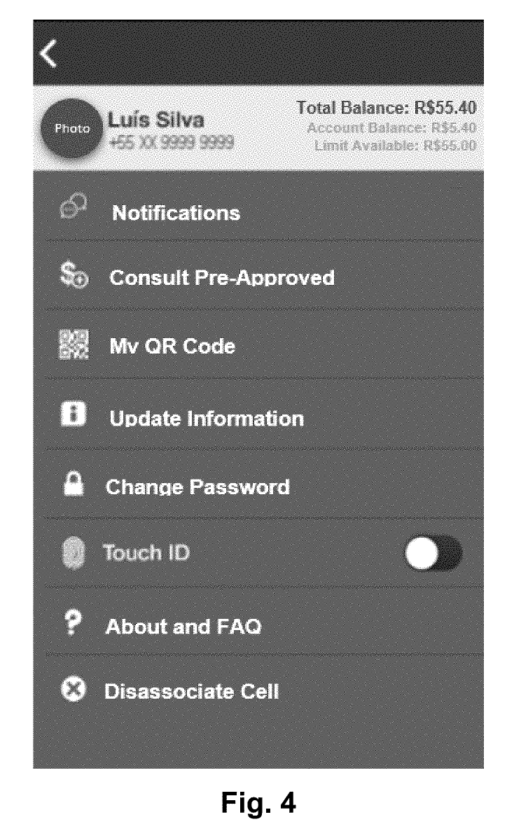

FIG. 4 represents the options for configuration of the user's profile/account.

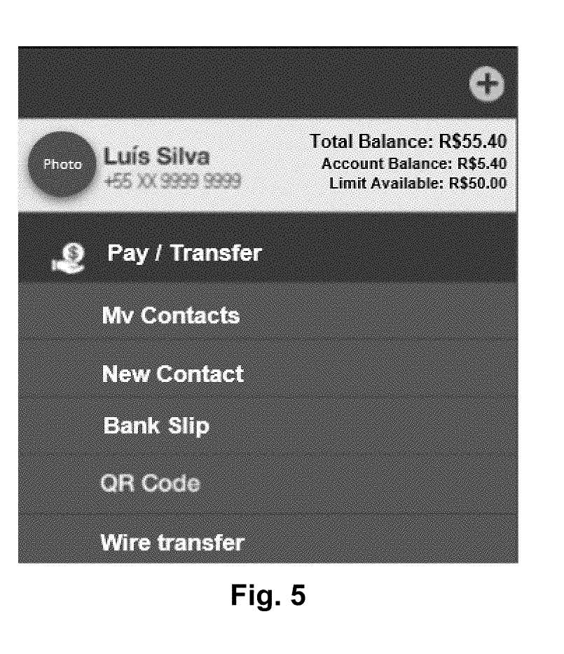

FIG. 5 represents, in detail, the options for payment/transfer to be made by the user.

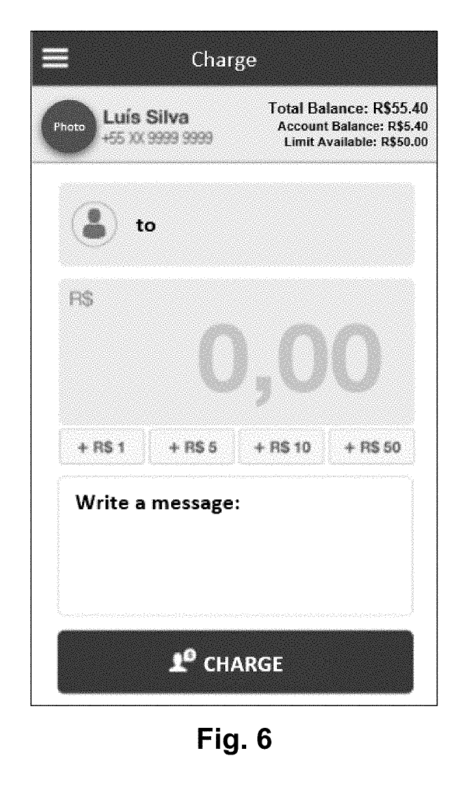

FIG. 6 represents, in detail, the means of making charges by the user.

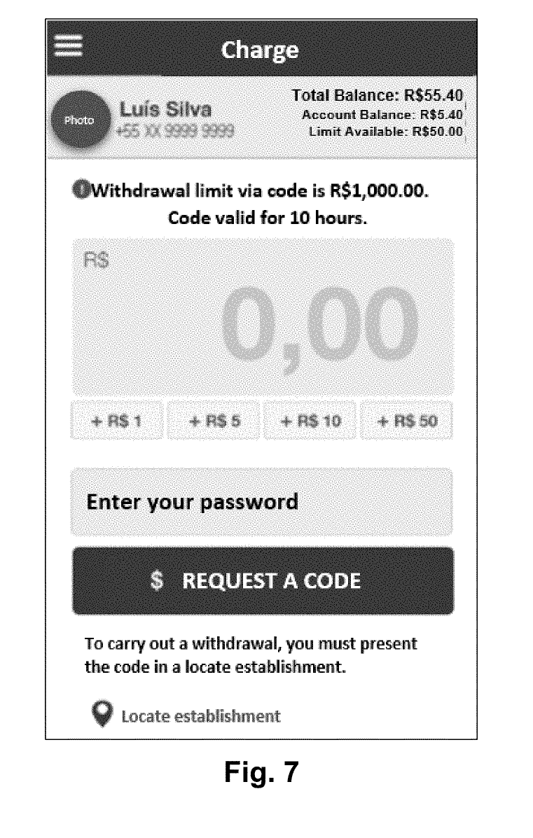

FIG. 7 represents, in detail, the form for requesting withdrawals on the part of the user.

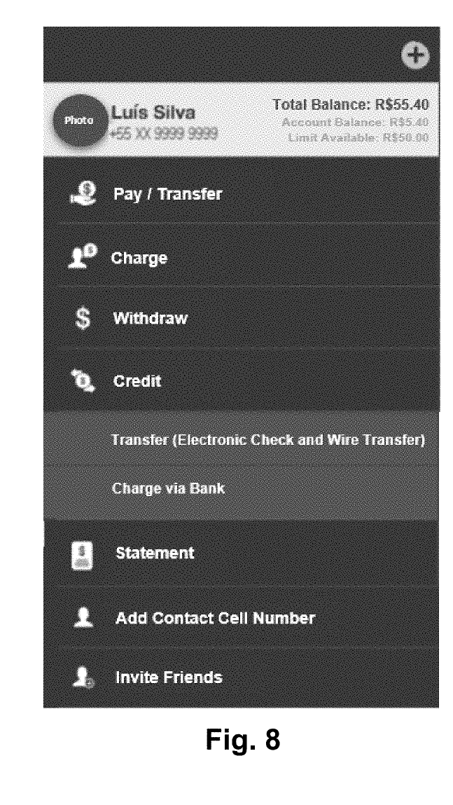

FIG. 8 represents, in detail, the options for recharging credit available to the user.

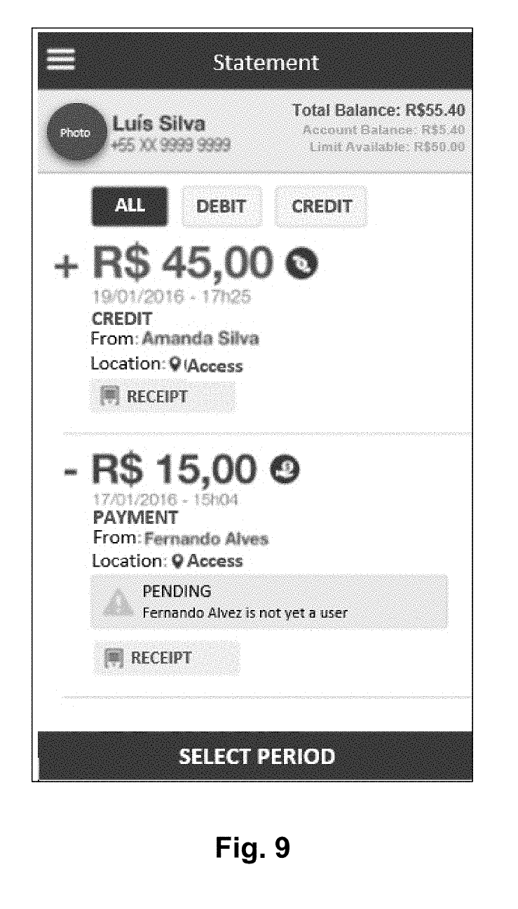

FIG. 9 represents, in detail, the form of presentation of the statement with the transactions carried out by the user.

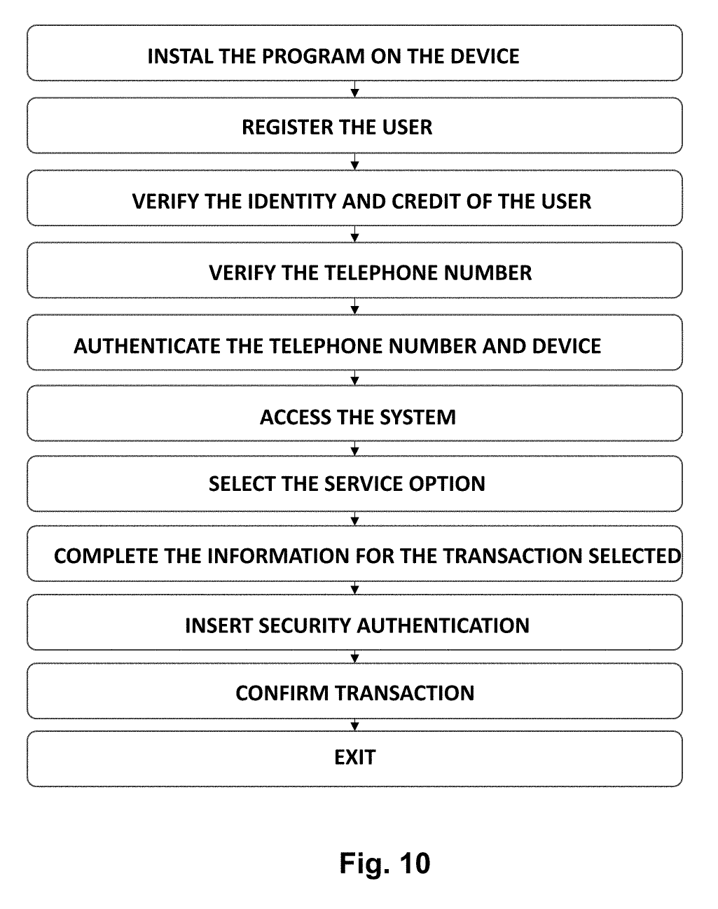

FIG. 10 represents the block diagram that indicates the steps of the method used for financial transactions via mobile or embedded device, in accordance with this invention.

### DETAILED DESCRIPTION OF THE INVENTION

This invention consists of a method and system used to carry out remote bank account financial transactions using a mobile device (4), comprising the installation of a program (5) directly connected to a central data processing unit (2) of a financial institution (1) through a web server (3), represented in the diagram in FIG. 1. Said program (5) comprises an interface with the user (6) which contains the service options to be accessed by the user, as exemplified in FIG. 3. For example: options for the payment of bills, transfer of funds, charges, account status and statements, as well as for adding new contacts with established accounts and carrying out transactions (payments and transfers) with new users who should install the system in order to receive the sums transferred.

In the case of subscription by a new user, following installation of the system, the user is directly sent to the registration section, necessary for opening a new account, or, in the case of a registered user, the login and password system of the existing account is opened, authorizing the user's access to the banking services available in the system hereby proposed. This form of access is already known to the state of the art and forms part of numerous systems, with varied fields of application. In addition to this, as a protocol, the system provides a tutorial with information on use, functionalities and benefits. However, it is important to mention that the technology proposed in this document also allows for the recognition of documents and information through an embedded intelligence module.

Thus, in order to confer advantages on the system, to achieve the aforementioned objectives, the mobile device (4) must possess Internet access in order, through connection via the web server (3) with the financial institution (1), that the system can enable the opening of an account online directly through the program. The system possesses an intelligence module that performs the instant verification, at the time of the registration, of the validity of the identity and status of the user's credit, associating each user cell number, provided at the moment of registration, with a bank account.

To carry out registration, as represented in FIG. 2, the user must complete the fields relating to personal/company data. With these data, the system allows the user to initiate financial transactions immediately following registration and validation of its telephone number, rendering swift and easy the process of opening bank accounts, and dispensing with the need for the user for wait for his/her credit analysis. As the opening of an account dispenses with the need for the presentation of documents and each telephone number provided by the user is unique and specific to an establishment or individual, its validation permits the user to use the system, facilitating transactions between different locations, cities and countries. It is known that each telephone number is unique, since there is no repetition of telephone numbers around the world due to the fact that the country area code combines with the area code of the user's region and the number assigned to the user itself. For example, the telephone number+555199900-0000 is assigned to a single user, since+55 defines the country code (in this case, Brazil), the code 51 defines the user's region (in this case a region in the state of Rio Grande do Sul) and 99900-0000 consists of the user's number.

The instant verification of the user's identification and credit occurs through the connection of the central data processing unit (2) of the financial institution (1) with data bases of organizations that comprise systems with rules related to the rights of the Consumer Defense Code, such as the Credit Protection Service (Serviço de Proteção ao Crédito—SPC) and the Centralization of Banking Services (Centralizaçáo dos Serviços Bancários S/A—SERASA) which provide proof and information regarding the credit restrictions or absence thereof of each citizen duly registered in the Individual Taxpayer Register (Cadastro de Pessoas Fisicas—CPF), sending back to the user authorization or otherwise to access the system, informing outstanding financial obligations where they exist.

This credit analysis is also facilitated since, at the time of registration, the system allows for the facial recognition of the user based on analysis of the photograph of a given document provided. As such, the user must photograph its document in order that the technology installed in the system can automatically classify the type of document presented and identify the user. Identification then occurs through OCR technology, from the English Optical Character Recognition, which recognizes characteristics based on digitalized documents, PDF files and images captured with digital cameras in researchable data. This reader technology is also used for other services provided by the system such as reading bank payment slips. Thus, using the intelligence module, the system performs the facial recognition of the user through a request for a selfie at the moment of registration. At the time of the request for the selfie, the user is instructed to take a photograph of its face in a lighted environment without using the camera flash. Following appropriate identification of the user, with the correct completion of the form with all the data requested, an SMS validation message is sent to its device informing it of the opening of the account. At the time of the opening of the account, the program (5) generates a QR code which will identify the user based on any transactions attributed thereto.

As mentioned above, for registration, the system requires the provision of a phone number, which must be checked by the system to confirm the identity. In addition to this, registration in the system may be realized in the name of a private individual or legal entity, provided that the data required are provided for confirmation and identification of the user, associating the telephone number provided with the respective account. Furthermore, for reasons of security, as shall be detailed below in the services available, it is essential that, should the user change their device, they alter all the information and data associated with the device. Which is to say, the system realizes the verification and authentication of the device (4) of the user. As such, this instruction must be respected and is explicitly described in the contractual terms of use for the program (5) of the system hereby proposed. The proposed system also provides a central client service platform comprising frequently asked questions, a field for the sending of emails regarding additional doubts, and explanations about the registration system and biometric identification which may be used in accordance with the technology provided by the mobile device used.

To carry out banking transactions, the program (5) provides a menu of options, as better specified and represented in FIG. 3. One of the options offered by the system consists of the option for payment or transfer of funds to current accounts. This type of transaction may be realized through a wire transfer (Documento de Ordem de Crédito—DOC), through an electronic check (Transferência Eletrônica Disponível—TED) or through QR code reading. In FIG. 5, the option for payment/transfer is more detailed, illustrating the transaction alternatives available to the user. Thus, to carry out a transaction of this kind, the user must select the contact from his contacts register who will receive the sum, indicating the sum to be transferred in the value-transfer field. Following authentication of the user (which may be done via password or biometry) and submission of the amount, a proof of payment is issued with a receipt number for the transaction. The user may share his/her contacts. In addition to this, if the user makes a transfer or payment and exceeds their bank account credit limit, they will have a time period to replace the sum that exceeded the standardized limit without being charged interest rates.

Moreover, should the user need to carry out a transfer of funds to a beneficiary who is not yet registered in the system hereby proposed, there is an alternative for transfers that remain pending following the sending of the notification of the transaction with an invitation for new users. In this case, the user must register the number of the beneficiary and perform the transaction. The beneficiary will receive notification via an SMS message on their mobile device informing the need to install the program (5) in order to receive the pending payment. The beneficiary will have a standardized time limit to install and create an account for installation of the program (5) on its mobile device (4) so that the transaction may be effectively realized. During this limited download period the user will have the value of the transfer blocked in their account. As a result, if the beneficiary does not carry out the download of the program (5), the sum will be returned/released to the account of the holder (user of the system who made the transfer).

If the user opts to make a payment directly to a user and/or establishment already registered in the proposed system, there is a possibility that this transaction will be realized through the QR code reader of the beneficiary. In this case, using access to the camera of the mobile device (4) the user will use the QR code reader of the beneficiary. Following the reading, the beneficiary's data will be automatically completed, requiring the user simply to inform the sum to be paid and the personal password to authorize the transaction.

Additionally, the proposed system realizes user profile identifications based on the identification of the locations most commonly frequented using GPS geolocation technology (8). As such, it is a purpose of this invention to establish a record of activities, easing identification of the establishment and date on which the user performed the transaction, automatically associating the respective account of the establishment with the option for performance of the payment.

As previously mentioned, there is a possibility of making payments to establishments or other users of the system based on QR code reading, from the English Quick Response, consisting of a reading of a two-dimensional bar code of the establishment/person itself which can easily be digitized using devices equipped with a camera (7). Thus, this information is converted for identification of an associated account of the establishment itself and/or the owner of said QR code. Thus, the user can transfer the sum to be paid intuitively, through the interface with the user (6) representing another novelty of the invention in question.

As previously mentioned, the system comprises options for financial transactions already existing in the market, such as the payment of bank payment slips. As such, after selecting the option of payment by the barcode reader, the camera of the mobile device is activated (7) so that the bank slip may be read. Additionally, there is a field for completing the barcode number of the slip in order that it can be entered manually.

Another innovative option that the proposed system offers to the user consists of the possibility of managing bills and the possibility of forming groups of users, where all the participants must have the system installed on their mobile devices (4). In this way, a sum can be established to be divided between the members of the group, and the system provides the charge in real time and monitoring of the user payers. By way of example, if a group of friends takes part in an event (a dinner, trip, etc.), there is a specific field for insertion of the total sum of the costs and the system automatically divides up the sum, sending a charge notification to each member of the group and, based on this, each user can authorize the payment that will enter directly into the account registered for receipt of the sum. The payment itself occurs through selection of the user to be charged or the group, with subsequent completion of the value field of the payment, its also being possible to attach a message to the payment. Once the charge has been issued, it is available for management by the user.

An option for cash withdrawals is also provided by the system, in accordance with the representation in FIG. 7, and said withdrawals may be made in partnership with federal lottery agencies and bank service providers. However, this option may be governed by daily limitations on the sum withdrawn determined by the agencies. Thus, in order to indicate the sum desired, the user must insert this value in the value-to-be-withdrawn field. Thereafter a code is generated to be provided by the user so that the withdrawal is approved by the closest lottery agency, which may also be indicated by the system through a GPS reading (8). This code is associated with a time limit for the withdrawal, and must be used within a standardized time period. If not, authorization for the withdrawal is cancelled and, if the user decides not to proceed with the withdrawal, the system cancels the authorization of the withdrawal and the code already provided is cancelled, thus increasing the security of the user.

In summary, in accordance with FIG. 7, the option to withdraw permanently includes information regarding the daily withdrawal limit and the period of validity of the code to be generated in order to keep the client informed of the processing of the withdrawal through the system. In addition to this, there are fields in the form for completion of the sum to be withdrawn, insertion of the user's password, and a button for requesting the code specifically generated for the withdrawal desired. This function also provides an option for informing the closest lottery agency through the geolocation system using GPS (8).

Thus, possessing the technologies and innovations described above, and access to the account through a login and password, the program (5) which forms part of the system proposed in this invention comprises, in its interface with the user (6), the user's basic data (profile), with photograph, name and cell phone number, as well as information about the total balance (account balance plus the limit), balance of the account and limit available. This information appears permanently during the use of the system, on all the screens, independently of the service option selected, keeping the user constantly informed of the status of his/her account.

Regarding the configurations of the user profile, represented in FIG. 4, the user interface comprises a selection item (icon) for accessing the system's field of configuration. On this screen, optional service fields can be found concerning: notifications, consultation of the pre-approved limit, indicating the revolving account limit in relation to the limit used, the available limit and total limit, as well as financial charges, such as monthly interest rates, annual interest rates and Effective Cost of Debt (ECD) per year; the user's QR code with an option for sharing; updating of data regarding email, ZIP, place name, street number, apartment number, district, city and state; alteration of password; activation/deactivation of biometry Touch ID); information about the system and frequently asked questions (client service); and disassociation of cell phone, an essential option when changing a cell phone device, as indicated above.

In addition to this, as illustrated in FIG. 4, the user interface (6) comprises an option to pay/transfer with the option to pay/transfer to: contacts already registered in the cell phone address book, where contacts with profile photos within the program's interface (5) indicate that they already possess the system and are duly registered. Thus, one may select the option for creating a group of users, choosing the members who will form part of the group; registration of a new contact with an option for inserting the cell phone number of the beneficiary who does not yet form part of the contacts list; payment of a bank slip using the barcode capture field to activate the camera (7), an option for manually inserting the barcode, a field for identifying the receipt, fields for completing the name of the beneficiary, the sum to be transferred, the date of payment, the button for confirmation of payment; payment using the QR code occurs in a similar manner to the reading of the barcode of the payment slip, as previously described; and payment by electronic check (TED), comprising fields for insertion of the data of the beneficiary (name Social Security Number (CPF)/Individual Taxpayer Number (CNPJ), bank/broker, agency number and account number).

In FIG. 8, an option for crediting the account is also available and comprises the options of transfer by electronic check (TED) or wire transfer (DOC) or bank payment slip, which consists of a field for insertion of the sum that the payment slip should present and a button for confirming the generation of the payment slip. Following this step, a payment slip number is generated with an option for displaying the payment slip and a copy of the identification field. In addition to this, data with the sum and date of payment are informed to the user, and the latter also has the option to share the payment slip or cancel the process.

Additionally, the system comprises a field for the addition of a new cell phone contact through the insertion of the number of a previously registered user, and also an invitation field, so that a request can be sent to an individual in order that the latter may install the proposed system for receipt of monetary payments/transferences. Finally, in order to leave the system, the user must press the leave button on the program's main screen (5). So, it is clear that through the implementation of these new technologies described above, applied to systems for financial transactions, that this invention seeks to become a facilitator of interactions between users of the system and their institution, as well as between establishments. It is also important to add that the system may also be installed in embedded systems, provided that they support the characteristic aspects of the invention, such as user identification based on a telephone number.

Thus, based on the previously described system it is possible to establish a method applicable to financial transactions via mobile or embedded devices. The method in question is initiated with the installation of the program (5) on the mobile device (4) of the user. It is then necessary for the user to carry out its registration including its data. These data consist of personal/company data, the creation of an access and security password, the inclusion of photos of identity documents, (identity card, driver's license or any other valid document) and the inclusion of a photo (selfie) of the user. In addition to this, the method in question comprises informing the user's phone number, due to the fact that the entire system and method are directly related to the association between the phone number provided and the bank account. Instantaneous verification is then made of the identification and credit of the user. The program (5) then carries out the verification and authentication of the telephone number and device (4) of the user, before sending an SMS message confirming the opening of the account.

The user must then access the system by using its password or through biometry, and select the option of the transaction desired from those available on the home screen of the interface with the user (6). After selecting the transaction option by choosing the transaction of interest on the screen, the respective data must be included for the realization of the selected service. It is then necessary to include a security authentication and finally to confirm the financial transaction. Once the requested transaction has been completed, the user may leave the system, by pressing the leave button in the program (5).

In this case, by way of example, if it is in the interest of the user to perform a transaction relating to payment/transfers, the data to be provided consist of the beneficiary's phone number, the sum and the security authentication. It is highlighted that this security authentication may be realized through the inclusion of the user's password or by biometry reading. Since it is only the beneficiary's telephone number that identifies him/her, the security of the performance of the transaction is clear, avoiding the possibility of typing or other errors concerning the data currently required by banking systems.

The innovation proposed in this invention is clear, bearing in mind that no such technology is currently known to the market, for facilitating transactions, and which is able to standardize the data used to identify a user's account. As such, it can be seen that the technology hereby proposed creates a standard which substantially optimizes international transactions, since the user's telephone number is the number related to the user's account and this information is effectively the only such to be used to carry out transactions.

It is important to highlight that the Figures and description presented are not intended to limit the forms of execution of the inventive concept hereby proposed, but rather to illustrate and render comprehensible the conceptual innovations revealed in this solution. As such, the descriptions and images should be interpreted as being illustrative and not limiting, its being possible that other equivalent and analogous forms of implementing the inventive concept hereby revealed may exist which do not exceed the scope of protection outlined in the proposed solution.

This description offers an improvement on the applied system and method for bank transactions carried out using a mobile device, possessing novelty, nonobviousness, descriptive sufficiency, utility and, consequently, all the requirements essential for the granting of the privilege requested.

1. A SYSTEM APPLIED TO FINANCIAL TRANSACTIONS VIA A MOBILE OR EMBEDDED DEVICE which comprises:
a connection via a web server (3) of a financial institution (1) possessing a central data processing unit (2) and at least one mobile device (4) with a program (5) for interface (6) with a user, said program (5) providing access through a login and password, or optionally a registration of a new online user characterized in that a telephone number code associated with the user's mobile device is used as an identifier of a bank account associated with the user.

2. THE SYSTEM APPLIED TO FINANCIAL TRANSACTIONS VIA A MOBILE DEVICE, according to claim 1, characterized in that the system further provides:
the user with a specific QR code which identifies the user and the corresponding bank account.

3. THE SYSTEM APPLIED TO FINANCIAL TRANSACTIONS VIA A MOBILE DEVICE according to claim 1, characterized in that:
the system uses geolocation technology to determine the history of transactions and places where they occur.

4. THE SYSTEM APPLIED TO FINANCIAL TRANSACTIONS VIA A MOBILE DEVICE according to claim 1, characterized in that the system further possesses:
an interface (6) with options for generating charges, requesting card-less withdrawals, adding previously registered contacts and sending payments/transfers/charges to new users.

5. THE SYSTEM APPLIED TO FINANCIAL TRANSACTIONS VIA A MOBILE DEVICE according to claim 1, characterized in that:
the confirmation of the password for identification of the user is substituted by the biometry recognition of the user using a fingerprint sensor on the user's mobile device.

6. THE SYSTEM APPLIED TO FINANCIAL TRANSACTIONS VIA A MOBILE DEVICE according to claim 1, characterized in that:
the confirmation of the password for identification of the user is substituted by facial recognition technology.

7. THE SYSTEM APPLIED TO FINANCIAL TRANSACTIONS VIA A MOBILE DEVICE according to claim 1, characterized in that:
the system further comprises the opening of the user's account through the instantaneous identification of the user through confirmation of their identity in a data base informing credit restrictions, credit verification and validation of the telephone number and mobile device of the user.

8. THE SYSTEM APPLIED TO FINANCIAL TRANSACTIONS VIA A MOBILE DEVICE according to claim 4, characterized in that:
the system further has an option for payment/transfer/charging to be realized through inclusion of the telephone contact of the beneficiary user/debtor previously registered in the contacts book of the user's mobile device in said system.

9. THE SYSTEM APPLIED TO FINANCIAL TRANSACTIONS VIA A MOBILE DEVICE according to claim 4, characterized in that:
the identification of the beneficiary user/debtor for realization of payments/transfers/charges is made by the specific QR code reading generated by said system which identifies the bank account of the beneficiary/debtor user.

10. THE SYSTEM APPLIED TO FINANCIAL TRANSACTIONS VIA A MOBILE DEVICE according to claim 4, characterized in that:
the system optionally provides for payments/transfers/charges to be made to contacts not yet registered in said system and comprises the sending of a notification via SMS message from the user registered in the system to the new unregistered user to download the program (5).

11. THE SYSTEM APPLIED TO FINANCIAL TRANSACTIONS VIA A MOBILE DEVICE according to claim 4, characterized in that:
the option for managing charges comprises the automatic verification of the system regarding the users that made the payment.

12. THE SYSTEM APPLIED TO FINANCIAL TRANSACTIONS VIA A MOBILE DEVICE according to claim 4, characterized in that:
the option for managing charges comprises the manual monitoring of the beneficiary user regarding the payments received.

13. THE SYSTEM APPLIED TO FINANCIAL TRANSACTIONS VIA A MOBILE DEVICE according to claim 12, characterized in that:
the charging that may be divided up between a group of users.

14. THE SYSTEM APPLIED TO FINANCIAL TRANSACTIONS VIA A MOBILE DEVICE according to claim 4, characterized in that:
the option of requesting withdrawals comprises the generation of a withdrawal code for the user.

15. THE SYSTEM APPLIED TO FINANCIAL TRANSACTIONS VIA A MOBILE DEVICE according to claim 4, characterized in that:
the system further provides the status of the account and bank statements comprising information about the transactions made during a given period and a record of the locations where the financial transactions occurred obtained through a geolocation system (8).

16. THE SYSTEM APPLIED TO FINANCIAL TRANSACTIONS VIA A MOBILE DEVICE according to claim 1, characterized in that:
the new user downloads the program (5) to receive the pending payment with a standardized time limit for the download and the creation of the account.

17. THE SYSTEM APPLIED TO FINANCIAL TRANSACTIONS VIA A MOBILE DEVICE according to claim 4, characterized in that:
the system automatically blocks the transfer of the sum in the account of the transferring user, with subsequent release, if the new beneficiary user does not carry out the registration and create an account within the download time limit.

18. A METHOD APPLIED TO FINANCIAL TRANSACTIONS VIA A MOBILE OR EMBEDDED DEVICE which comprises the following steps:
Carrying out installation of the program (5) on the mobile device (4);
Registering a User;
Verifying the user's identity;
Verifying the user's credit;
Authenticating the user's device;
Accessing the system; and
Selecting the option of the financial transaction to be made, characterized in that the user inserts a numerical code associated with the user's mobile device in the registration of the program and said code is used as a means of identifying the user's bank account and identity.

19. THE METHOD APPLIED TO FINANCIAL TRANSACTIONS VIA A MOBILE OR EMBEDDED DEVICE according to claim 18, characterized in that the system further comprises the following steps:
completing the data related to the required transaction;
inserting a security authentication; and
confirming the transaction.

20. THE METHOD APPLIED TO FINANCIAL TRANSACTIONS VIA A MOBILE OR EMBEDDED DEVICE according to claim 19, characterized in that:
the step of completing the data relating to the financial transaction consists of including the telephone number of the beneficiary user.

21. THE METHOD APPLIED TO FINANCIAL TRANSACTIONS VIA A MOBILE OR EMBEDDED DEVICE according to claim 19, characterized in that:
the step of completing the data relating to the financial transaction consists of the reading of a specific QR code which identifies the bank account of the beneficiary user.

22. THE METHOD APPLIED TO FINANCIAL TRANSACTIONS VIA A MOBILE OR EMBEDDED DEVICE according to claim 19, characterized in that:
the step of inserting the security authentication is performed by insertion of personal password or through a biometry reading.
